(19) United States
(12) Patent Application Publication
(10) Pub. No.: US 2024/0062942 A1
(43) Pub. Date: Feb. 22, 2024

(54) COIL DEVICE

(71) Applicant: Mitsubishi Electric Corporation, Tokyo (JP)

(72) Inventors: Kosuke INOUE, Tokyo (JP); Shogo MIKI, Tokyo (JP); Keiji SAKIMOTO, Tokyo (JP)

(73) Assignee: Mitsubishi Electric Corporation, Tokyo (JP)

(21) Appl. No.: 18/326,609

(22) Filed: May 31, 2023

(30) Foreign Application Priority Data
Aug. 18, 2022 (JP) 2022-130317

(51) Int. Cl. H01F 27/08; H01F 27/28; H01F 27/26; H01F 27/02

(52) U.S. Cl. CPC H01F 27/08; H01F 27/2847; H01F 27/266; H01F 27/022

(57) ABSTRACT

Heat emitted from a plurality of stacked coils forming a coil body can be dissipated from the coils on all the layers. A coil device includes a core mounted on a mounting surface of a cooler, a coil body formed by stacking, on the mounting surface, a lower-layer coil and an upper-layer coil having winding portions wound about a winding axis of the core, and heat dissipation members provided on the cooler. The upper-layer coil positioned on a layer other than the lowermost layer has extending portions extending in directions away from the winding axis. The extending portions, and the winding portion of the lower-layer coil positioned on the lowermost layer abut on the heat dissipation members.

### TECHNICAL FIELD

The present disclosure relates to a coil device.

### BACKGROUND ART

In a case where a coil device such as a transformer or a reactor is to be mounted on a vehicle or the like, it is necessary to contrive a device that prevents components from falling off due to vibrations. For example, a coil device disclosed in Patent Literature 1 adopts an anti-vibration structure in which a coil body includes a coil unit arranged around a magnetic core, and a coil case housing the coil unit, and the space between the coil unit and the coil case is filled with a sealing material.

### CITATION LIST

### Patent Literature

Patent Literature 1: Japanese Patent No. 6061172

### SUMMARY OF INVENTION

### Technical Problem

Heat emitted from the coil body of the coil device disclosed in Patent Literature 1 at the time of operation needs to be dissipated from the coil body. In this case, the heat emitted from the coil body is dissipated to the outside of the device after being transferred to the coil case via the sealing material. However, since the heat emitted from the coil body is transferred inside the sealing material, and dissipated from the coil device disclosed in Patent Literature 1, the heat dissipation property of the coil body deteriorates undesirably.

For example, in a case where a coil body formed by stacking a plurality of coils is included, there is a possibility that the degree of deterioration of the heat dissipation property of coils positioned on upper layers and arranged at positions far from a location of dissipation of heat increases as the distances between those coils and the location of dissipation of heat increase.

The present disclosure has been made to solve problems as described above, and an object thereof is to provide a coil device by which heat emitted from a plurality of stacked coils forming a coil body can be dissipated from the coils on all the layers.

### Solution to Problem

A coil device according to the present disclosure includes: a core mounted on a mounting surface of a cooler; a first coil body formed by stacking, on the mounting surface, a plurality of coils having winding portions wound about a winding axis of the core; and a heat dissipation member provided for the cooler, in which among the plurality of coils, a coil positioned on a layer other than a lowermost layer has an extending portion extending in a direction away from the winding axis, and the extending portion and a winding portion of a coil positioned on the lowermost layer abut on the heat dissipation member.

### Advantageous Effects of Invention

According to the present disclosure, heat emitted from a plurality of stacked coils forming a coil body can be dissipated from the coils on all the layers.

### BRIEF DESCRIPTION OF DRAWINGS

FIG. 1 is a perspective view depicting the external appearance of a coil device according to a first embodiment.

FIG. 2 is a perspective view in a state where resin members and pressing members are removed from the coil device according to the first embodiment.

FIG. 3A and FIG. 3B are each a figure depicting the configuration of the coil device according to the first embodiment.

FIG. 3A is a plan view of the coil device according to the first embodiment.

FIG. 3B is a plan view in a state where the resin members and the pressing members are removed from the coil device according to the first embodiment.

FIG. 4 is a cross-sectional view taken along a plane represented by arrows IV-IV in FIG. 3A.

FIG. 5 is an exploded perspective view of a coil body.

FIG. 6 is a vertical cross-sectional view of a coil device according to a second embodiment.

FIG. 7 is a plan view in a state where the resin members and the pressing members are removed from a coil device according to a third embodiment.

FIG. 8 is a cross-sectional view taken along a plane represented by arrows VIII-VIII in FIG. 7.

FIG. 9 is a plan view in a state where the resin members and the pressing members are removed from a coil device according to a fourth embodiment.

FIG. 10 is a vertical cross-sectional view of a coil device according to a fifth embodiment.

FIG. 11 is an exploded perspective view of the coil body included in a coil device according to a sixth embodiment.

FIG. 12 is a plan view of a coil device according to a seventh embodiment.

### DESCRIPTION OF EMBODIMENTS

Embodiments according to the present disclosure are explained in detail below with reference to the figures.

### First Embodiment

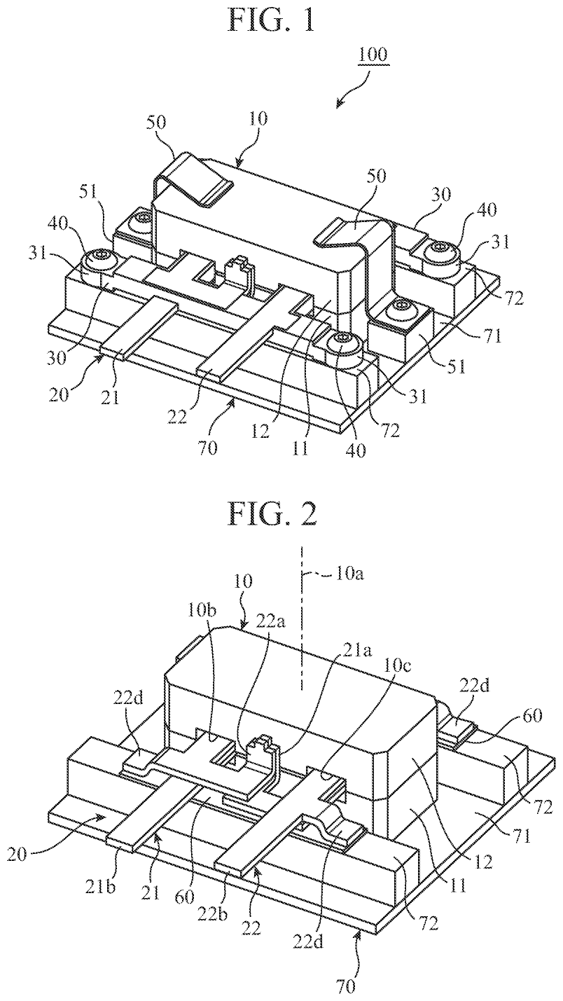

A coil device 100 according to a first embodiment is explained by using FIG. 1 to FIG. 5.

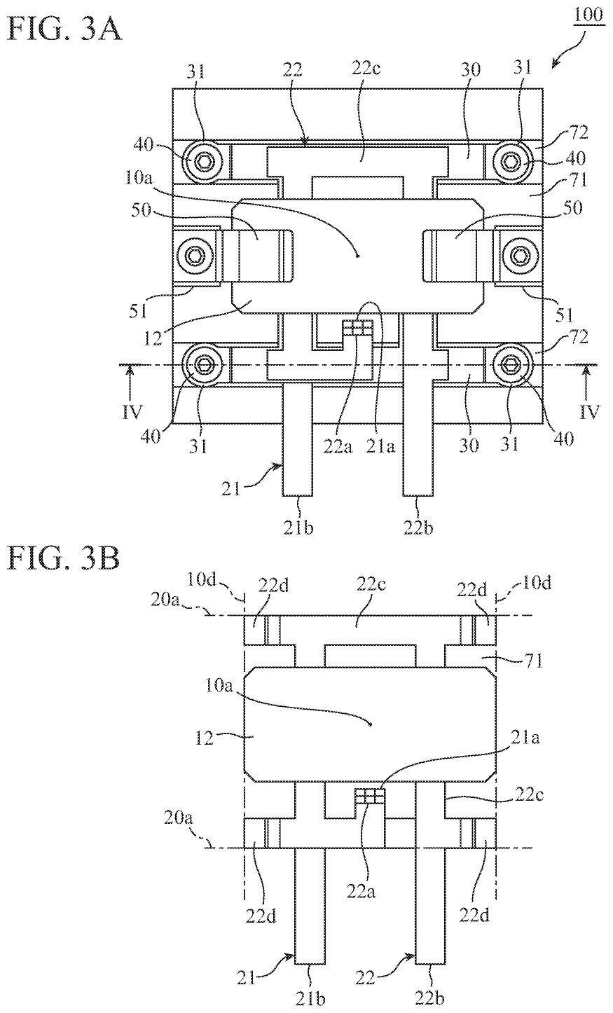

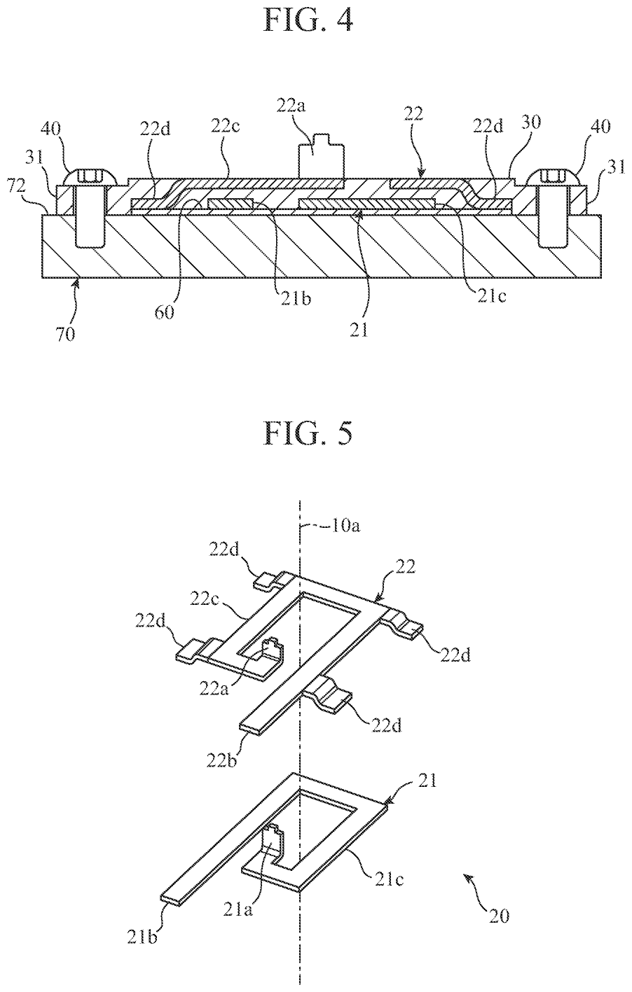

FIG. 1 is a perspective view depicting the external appearance of the coil device 100 according to the first embodiment. FIG. 2 is a perspective view in a state where resin members 30 and pressing members 50 are removed from the coil device 100 according to the first embodiment. FIG. 3A and FIG. 3B are each a figure depicting the configuration of the coil device 100 according to the first embodiment. FIG. 4 is a cross-sectional view taken along a plane represented by arrows IV-IV in FIG. 3A. FIG. 5 is an exploded perspective view of a coil body 20.

Note that in explanations of the coil device 100 depicted below, for example, a diagonal depthwise direction in FIG. 1 is treated as the front-back direction (longitudinal direction), a diagonal left-right direction in FIG. 1 is treated as the widthwise direction (lateral direction), and an up-down direction in FIG. 1 is treated as the up-down direction (height direction).

As depicted in FIG. 1 to FIG. 4, the coil device 100 according to the first embodiment includes a core 10, the coil body 20 forming a first coil body, the resin members 30, fixation members 40, the pressing members 50, heat dissipation members 60 and a cooler 70. The core 10, the coil body 20, the resin members 30, the fixation members 40, the pressing members 50 and the heat dissipation members 60 are provided above the cooler 70.

The cooler 70 is for cooling the core 10 and the coil body 20. Heat emitted from the core 10 and the coil body 20 is dissipated to the cooler 70. FIG. 1 depicts only the upper portion of the cooler 70.

The cooler 70 has one mounting surface 71 and two protrusion surfaces 72. For example, the mounting surface 71 and the protrusion surfaces 72 are flat surfaces that form the upper surface of the cooler 70.

The mounting surface 71 is disposed at a central portion in the front-back direction on the upper surface of the cooler 70. The mounting surface 71 is formed as a surface that is long in the widthwise direction.

The protrusion surfaces 72 are arranged at positions higher than the height position of the mounting surface 71. Specifically, the protrusion surfaces 72 are formed in such a manner that the protrusion surfaces 72 protrude upward from the mounting surface 71. The protrusion surfaces 72 are arranged next to each other on both sides, in the front-back direction, of the mounting surface 71. The protrusion surfaces 72 are formed as surfaces that are long in the widthwise direction, and have widths which are the same as the width of the mounting surface 71. In addition, each protrusion surface 72 is provided with a heat dissipation member 60. Note that details of the heat dissipation members 60 are mentioned later.

The core 10 is mounted on the mounting surface 71 of the cooler 70. The core 10 is approximately a rectangular parallelepiped, and the width of the core 10 is longer than the length of the core 10 in the front-back direction. Note that the core 10 is formed of ferrite, for example.

In addition, the core 10 includes a plurality of split cores. For example, the core 10 is formed by combining together two split cores 11 and 12 in the up-down direction. The split cores 11 and 12 have the same size, and have the same shape.

The split core 11 forms the lower half of the core 10, and is mounted on the mounting surface 71 of the cooler 70. The split core 11 has an E shape when seen from side. The split core 11 is disposed in such a way that its two openings face upward. The split core 12 forms the upper half of the core 10. The split core 12 has an E shape when seen from side. The split core 12 is disposed in such a way that its two openings face downward.

The split cores 11 and 12 are combined in such a way that the openings of the split cores 11 and 12 face each other in the up-down direction. In this manner, the central axis of the split cores 11 and 12 that are caused to face each other serves as a winding axis 10a. In addition, by causing each of the two openings of the split core 11 to face a corresponding one of the two openings of the split core 12, two coil insertion paths 10b and 10c are formed.

Note that whereas both the split cores 11 and 12 have E shapes when seen from side, one split core of the split cores 11 and 12 may have an E shape when seen from side, and the other split core may have an I shape when seen from side. In addition, there are no problems even when one split core of the split cores 11 and 12 has a U shape when seen from side, and the other split core has an I shape when seen from side. Furthermore, both the split cores 11 and 12 may have U shapes when seen from side.

The coil body 20 is wound about the winding axis 10a of the core 10. At this time, the coil body 20 passes through the coil insertion paths 10b and 10c of the core 10. In addition, the coil body 20 is formed by stacking a plurality of coils on the mounting surface 71 of the cooler 70. For example, the coil body 20 has two coils (hereinafter, referred to as a lower-layer coil 21 and an upper-layer coil 22). In this case, the lower-layer coil 21 is the lowermost-layer coil, and the upper-layer coil 22 is the uppermost-layer coil.

The coil body 20 has a dual-layer structure (dual-turn structure) in which there is a clearance with a predetermined size in the up-down direction between the lower-layer coil 21 and the upper-layer coil 22, and the lower-layer coil 21 and the upper-layer coil 22 are joined in series. At this time, the lower-layer coil 21 and the upper-layer coil 22 pass through the coil insertion paths 10b and 10c, and are wound about the winding axis 10a rectangularly and annularly. In addition, the lower-layer coil 21 and the upper-layer coil 22 are supported by the core 10 in a state where the lower-layer coil 21 and the upper-layer coil 22 are spaced apart upward from the mounting surface 71 of the cooler 70.

The widthwise dimension of the lower-layer coil 21 along the lengthwise direction, and the widthwise dimension of the upper-layer coil 22 along the lengthwise direction are approximately uniform. The widthwise dimension of the lower-layer coil 21 and the widthwise dimension of the upper-layer coil 22 are the same. For example, the lower-layer coil 21 and the upper-layer coil 22 are sheet metal members with elongated, flat-plate-like shapes, and are formed of a metal material such as copper, a copper alloy or an aluminum alloy.

As depicted in FIG. 5, the lower-layer coil 21 has a joint portion 21a, a terminal portion 21b and a winding portion 21c.

The joint portion 21a forms one end portion of the lower-layer coil 21. The joint portion 21a is formed by bending one end side of the lower-layer coil 21 upward. In addition, the joint portion 21a is disposed on the inner side of the winding portion 21c mentioned later.

The terminal portion 21b forms the other end portion of the lower-layer coil 21, and one end portion of the coil body 20. The terminal portion 21b can be electrically connected with an external electronic component. The other end side of the lower-layer coil 21 extends forward from the coil insertion path 10b of the core 10, and abuts on the heat dissipation member 60 provided on the protrusion surface 72. That is, the terminal portion 21b is thermally connected to the cooler 70 via the heat dissipation member 60. Then, a portion that is part of the lower-layer coil 21, and located on the outer side (in front) of the protrusion surface 72 serves as the terminal portion 21b.

In the lengthwise direction of the lower-layer coil 21, the winding portion 21c is provided between the joint portion 21a and the terminal portion 21b. The winding portion 21c is wound about the winding axis 10a rectangularly and annularly. The winding portion 21c forms such a rectangular annular shape that the length of the winding portion 21c in the front-back direction is longer than the width of the winding portion 21c. In addition, the front side of the winding portion 21c abuts on the surface of the heat dissipation member 60 provided on the protrusion surface 72. That is, the winding portion 21c is thermally connected to the cooler 70 via the heat dissipation member 60.

As depicted in FIG. 5, the upper-layer coil 22 has a joint portion 22a, a terminal portion 22b, a winding portion 22c and extending portions 22d.

The joint portion 22a forms one end portion of the upper-layer coil 22. The joint portion 22a is formed by bending one end side of the upper-layer coil 22 upward. In addition, the joint portion 22a is disposed on the inner side of the winding portion 22c mentioned later. In the front-back direction, the joint portion 21a and the joint portion 22a are joined by using TIG welding, resistance welding, ultrasonic welding, soldering, crimping or the like. The joint portion 22a is positioned before the joint portion 21a.

The terminal portion 22b forms the other end portion of the upper-layer coil 22, and the other end portion of the coil body 20. The terminal portion 22b can be electrically connected with an external electronic component. The other end side of the upper-layer coil 22 extends forward from the coil insertion path 10c of the core 10. Then, a portion that is part of the upper-layer coil 22, and located on the outer side (in front) of the protrusion surface 72 serves as the terminal portion 22b. The terminal portion 22b is disposed at a position higher than the height position of the terminal portion 21b.

In the lengthwise direction of the upper-layer coil 22, the winding portion 22c is provided between the joint portion 22a and the terminal portion 22b. The winding portion 22c is wound about the winding axis 10a rectangularly and annularly. The winding portion 22c forms such a rectangular annular shape that the length of the winding portion 22c in the front-back direction is longer than the width of the winding portion 22c. The winding portion 21c and the winding portion 22c are bodies with rectangular annular shapes having approximately the same size. In addition, the winding portion 21c and the winding portion 22c face each other in the up-down direction, and there is a clearance therebetween. That is, the winding portion 22c is disposed at a position higher than the height position of the winding portion 21c.

Corresponding to four corner portions of the winding portion 22c having a rectangular annular shape, the extending portions 22d are provided to the outer circumferential surface of the winding portion 22c. Each extending portion 22d is formed in a such a way that the extending portion 22d extends from the outer circumferential surface of the winding portion 22c in a direction away from the winding axis 10a, and thereby abuts on the surface of the heat dissipation member 60 provided on the protrusion surface 72. Specifically, each extending portion 22d gradually inclines toward the heat dissipation member 60 (located thereunder) in a direction outward in the widthwise direction from the outer circumferential surface of the winding portion 22c, and abuts on the surface of the heat dissipation member 60. Because of this, the extending portions 22d are thermally connected to the cooler 70 via the heat dissipation members 60.

The widthwise dimensions of the extending portions 22d are equal to or greater than the widthwise dimensions of the winding portions 21c and 22c. In addition, the extending portions 22d abut on the surfaces of the heat dissipation members 60 without extending beyond the edges of the surfaces of the heat dissipation members 60 in the widthwise direction. In addition, the extending portions 22d are arranged coplanarly with the terminal portion 21b and the winding portion 21c of the lower-layer coil 21.

Here, as depicted in FIG. 3B, two lines representing the positions, in the widthwise direction, of the coil device 100, of both side surfaces, in the widthwise direction, of the core 10 (the split cores 11 and 12) are defined as respective core profile lines 10d. In addition, two lines representing the positions, in the front-back direction, of the coil device 100, of both side surfaces, in the front-back direction, of the winding portions 21c and 22c are defined as respective coil profile lines 20a. Because of this, the core profile lines 10d and the coil profile lines 20a cross each other. Regarding this, all the extending portions 22d are arranged in an area surrounded by the core profile lines 10d and the coil profile lines 20a.

As mentioned above, the upper-layer coil 22 has the four extending portions 22d, but the quantity of extending portions 22d is not limited to this. For example, the quantity of extending portions 22d can be adjusted as appropriate depending on the exothermic temperature of the core 10, the exothermic temperature of the coil body 20 or the like.

Furthermore, the lower-layer coil 21 and the upper-layer coil 22 are fixed to each other by using the resin members 30. For example, the resin members 30 are insert-molded around the lower-layer coil 21 and the upper-layer coil 22. At this time, all the extending portions 22d of the upper-layer coil 22 are provided inside the resin members 30.

As depicted in FIG. 1, FIG. 3A and FIG. 4, the resin members 30 are provided on the respective protrusion surfaces 72 of the cooler 70 in a such a way that the resin members 30 cover the heat dissipation members 60 from above. The resin member 30 which is disposed behind the core 10 integrally holds together the winding portion 21c of the lower-layer coil 21, and the winding portion 22c and extending portions 22d of the upper-layer coil 22. On the other hand, the resin member 30 which is disposed in front of the core 10 integrally holds together the terminal portion 21b and winding portion 21c of the lower-layer coil 21, and the terminal portion 22b, winding portion 22c and extending portions 22d of the upper-layer coil 22.

The resin members 30 have fixation portions 31. The fixation portions 31 are formed on both end portions of the resin members 30. The fixation portions 31 are fixed to the protrusion surfaces 72 by using the fixation members 40. The resin members 30 are formed of a resin material such as polyphenylene sulfide, for example. The fixation members 40 are screws, presser bar springs or the like, for example. FIG. 1 depicts an example in which screws are used as the fixation members 40.

The pressing members 50 press the core 10 against the mounting surface 71 of the cooler 70. The pressing members 50 are provided on respective both sides of the core 10 in the widthwise direction. The base ends of the pressing members 50 are supported by the mounting surface 71 via support members 51. The ends of the pressing members 50 abut on the upper surface of the core 10 (the split core 12). The pressing members 50 are plate springs formed of a metal material such as stainless steel, for example.

The heat dissipation members 60 are provided on the protrusion surfaces 72 of the cooler 70 along the lengthwise direction of the protrusion surfaces 72. The heat dissipation member 60 which is disposed behind the core 10 is in contact with the winding portion 21c of the lower-layer coil 21, and the extending portions 22d of the upper-layer coil 22. On the other hand, the heat dissipation member 60 which is disposed in front of the core 10 is in contact with the terminal portion 21b and winding portion 21c of the lower-layer coil 21, and the extending portions 22d of the upper-layer coil 22. In addition, the widthwise dimensions of the heat dissipation members 60 along the lengthwise direction are equal to or greater than the widthwise dimensions of the winding portions 21c and 22c, and the widthwise dimensions of the extending portions 22d.

It is sufficient if at least one protrusion surface 72 of the two protrusion surfaces 72 is provided with the heat dissipation member 60 depending on the exothermic temperature of the core 10, the exothermic temperature of the coil body 20 or the like. Such a heat dissipation member 60 is a heat dissipation sheet with an elongated, flat-plate-like shape, for example, and is formed of silicone or the like. At this time, there are no problems even when the heat dissipation property and insulating property of the heat dissipation member 60 are enhanced by mixing a filler or the like to the material of the heat dissipation member 60. Note that there are no problems even when grease or an adhesive is used instead of the heat dissipation members 60.

For example, the cooler 70 includes therein a refrigerant path through which a refrigerant flows. Because of this, the cooler 70 can efficiently absorb heat emitted from the core 10 and the coil body 20, and cool the core 10 and the coil body 20. Note that not only the core 10, but another device (e.g. an electric power conversion device) may be mounted on the mounting surface 71 of the cooler 70. In this case, there are no problems even when the cooler 70 includes a lid member that covers and houses thereunder the core 10 and another device.

Accordingly, heat emitted from the core 10 is transferred to the mounting surface 71 of the cooler 70, and is thereby dissipated to the cooler 70. In addition, heat emitted from the lower-layer coil 21 is dissipated from the terminal portion 21b and the winding portion 21c of the lower-layer coil 21 to the cooler 70 via the heat dissipation members 60. Furthermore, heat emitted from the upper-layer coil 22 is dissipated from the extending portions 22d of the upper-layer coil 22 to the cooler 70 via the heat dissipation members 60.

As a result, without providing a sealing material, and a coil case for housing the sealing material, heat emitted from a plurality of stacked coils forming the coil body 20 in the coil device 100 can be dissipated from the coils on all the layers. In addition, since the coil device 100 does not include a sealing material and a coil case, it is possible to attempt to reduce the device size, and reduce the manufacturing cost.

As explained thus far, the coil device 100 according to the first embodiment includes the core 10 mounted on the mounting surface 71 of the cooler 70, the coil body 20 formed by stacking, on the mounting surface 71, the lower-layer coil 21 and the upper-layer coil 22 having the winding portions 21c and 22c wound about the winding axis 10a of the core 10, and the heat dissipation members 60 provided for the cooler 70. The upper-layer coil 22 positioned on a layer other than the lowermost layer has the extending portions 22d extending in directions away from the winding axis 10a. The extending portions 22d, and the winding portion 21c of the lower-layer coil 21 positioned on the lowermost layer abut on the heat dissipation members 60. Because of this, heat emitted from the plurality of stacked coils forming the coil body 20 in the coil device 100 can be dissipated from the coils on all the layers.

In the coil device 100, the extending portions 22d, and the winding portion 21c of the lower-layer coil 21 positioned on the lowermost layer are arranged coplanarly. Because of this, in the coil device 100, the winding portion 21c of the lower-layer coil 21, and the extending portions 22d of the upper-layer coil 22 can be caused to abut on one heat dissipation member 60. As a result, via the one heat dissipation member 60, the coil device 100 enables dissipation of heat emitted from the lower-layer coil 21, and heat emitted from the upper-layer coil 22.

In the coil device 100, at least one end portion of both end portions of the coil body 20 is disposed coplanarly with the extending portions 22d, and the winding portion 21c of the lower-layer coil 21 positioned on the lowermost layer. Because of this, in the coil device 100, an end portion (the terminal portion 21b) of the coil body 20, the winding portion 21c of the lower-layer coil 21, and the extending portions 22d of the upper-layer coil 22 can be caused to abut on one heat dissipation member 60. As a result, via the one heat dissipation member 60, the coil device 100 enables dissipation of heat emitted from the lower-layer coil 21, and heat emitted from the upper-layer coil 22.

The coil device 100 includes the resin members 30 that fix at least integrally the winding portion 21c of the lower-layer coil 21, and the extending portions 22d of the upper-layer coil 22, and the protrusion surfaces 72 that are formed on the cooler 70, and arranged at positions higher than the height position of the mounting surface 71. The heat dissipation members 60 are provided on the protrusion surfaces 72, and the resin members 30 are provided on the protrusion surfaces 72 in such a way that the resin members 30 cover the heat dissipation members 60. Because of this, in the coil device 100, the winding portion 21c and the extending portions 22d can be prevented from falling off from the heat dissipation members 60.

In the coil device 100, the extending portions 22d are arranged in an area surrounded by the core profile lines 10d representing the positions of both side surfaces of the core 10 in the widthwise direction, and the coil profile lines 20a representing the positions of both side surfaces of the winding portions 21c and 22c in the front-back direction. Because of this, the extending portions 22d are arranged in the limited area in the coil device 100, so that it is possible to attempt to reduce the device size.

In the coil device 100, the widthwise dimensions of the extending portions 22d are equal to or greater than the widthwise dimensions of the winding portions 21c and 22c. Because of this, the extending portions 22d in contact with the heat dissipation members 60 can have larger sizes in the coil device 100, so that the heat dissipation property can be enhanced.

In the coil device 100, the widthwise dimensions of the heat dissipation members 60 are equal to or greater than the widthwise dimensions of the winding portions 21c and 22c and the widthwise dimensions of the extending portions 22d. Because of this, it is possible to attempt to enhance the ease of assembly of the coil device 100.

### Second Embodiment

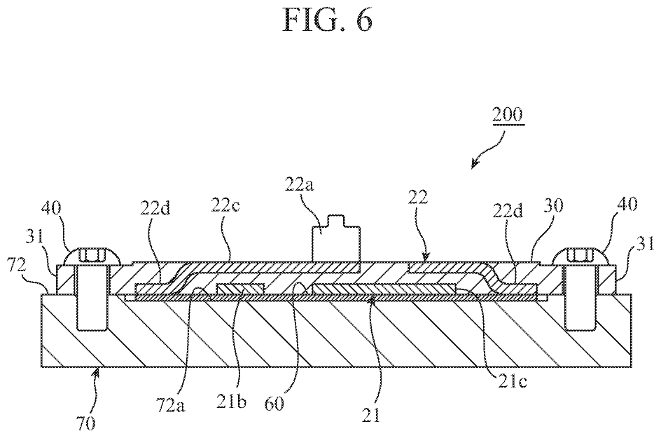

A coil device 200 according to a second embodiment is explained by using FIG. 6. FIG. 6 is a vertical cross-sectional view of the coil device 200 according to the second embodiment. Note that constituent elements having functions which are similar to those of constituent elements explained in the first embodiment mentioned above are given identical reference signs, and explanations thereof are omitted.

As depicted in FIG. 6, the coil device 200 according to the second embodiment has the configuration in which recesses 72a are added to the configuration of the coil device 100 according to the first embodiment depicted in FIG. 1.

The recesses 72a are provided on the protrusion surfaces 72 of the cooler 70. That is, the recesses 72a are recessed downward from the protrusion surfaces 72. The recesses 72a are for housing the heat dissipation members 60. Because of this, the winding portion 21c of the lower-layer coil 21, the extending portions 22d of the upper-layer coil 22, and the fixation portions 31 of the resin members 30 are arranged coplanarly. As a result, the resin members 30 prevent positional misalignment of the heat dissipation members 60, and also it is possible to cause the winding portion 21c of the lower-layer coil 21, and the extending portions 22d of the upper-layer coil 22 to abut on the heat dissipation members 60 easily.

As explained thus far, in the coil device 200, the protrusion surfaces 72 have the recesses 72a that house the heat dissipation members 60. Because of this, in the coil device 200, positional misalignment of the heat dissipation members 60 is prevented, and also it is possible to cause the winding portion 21c of the lower-layer coil 21, and the extending portions 22d of the upper-layer coil 22 to abut on the heat dissipation members 60 easily.

### Third Embodiment

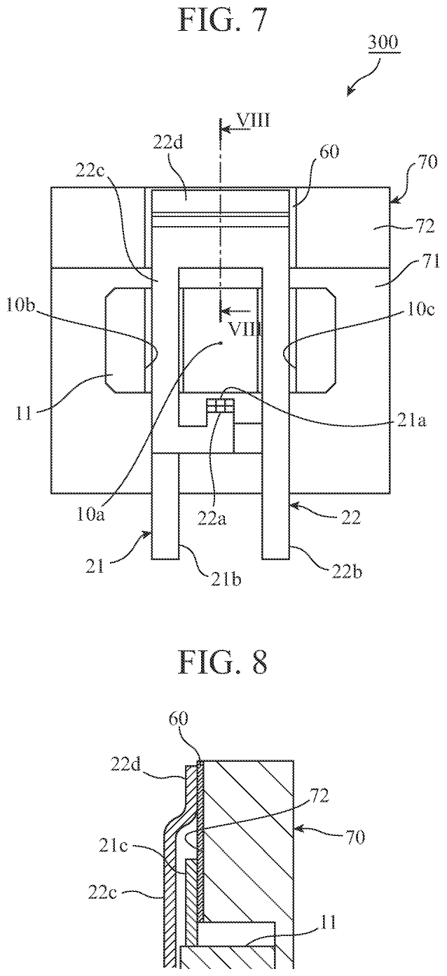

A coil device 300 according to a third embodiment is explained by using FIG. 7 and FIG. 8. FIG. 7 is a plan view in a state where the resin members 30 and the pressing members 50 are removed from the coil device 300 according to the third embodiment. FIG. 8 is a cross-sectional view taken along a plane represented by arrows VIII-VIII in FIG. 7. In FIG. 7 and FIG. 8, the split core 12 is omitted. Note that constituent elements having functions which are similar to those of constituent elements explained in the first embodiment mentioned above are given identical reference signs, and explanations thereof are omitted.

The coil device 100 according to the first embodiment depicted in FIG. 1 includes the four extending portions 22d. In contrast to this, as depicted in FIG. 7 and FIG. 8, the coil device 300 according to the third embodiment includes one extending portion 22d. The extending portion 22d is positioned on a side opposite to both end portions of the coil body 20 (the terminal portion 21b of the lower-layer coil 21, and the terminal portion 22b of the upper-layer coil 22) relative to the winding axis 10a as the axis of symmetry.

The cooler 70 has one protrusion surface 72. The one protrusion surface 72 is next to the mounting surface 71 on the rear side of the mounting surface 71. In addition, the protrusion surface 72 is provided with a heat dissipation member 60.

Regarding this, the rear side of the winding portion 21c of the lower-layer coil 21 abuts on the surface of the heat dissipation member 60. Because of this, the winding portion 21c is thermally connected to the cooler 70 via the heat dissipation member 60.

The extending portion 22d of the upper-layer coil 22 is formed in a such a way that the extending portion 22d extends from the outer circumferential surface of the winding portion 22c in a direction away from the winding axis 10a, and thereby abuts on the surface of the heat dissipation member 60 provided on the protrusion surface 72. Specifically, the extending portion 22d gradually inclines toward the heat dissipation member 60 in a direction backward from the outer circumferential surface of the winding portion 22c, and abuts on the surface of the heat dissipation member 60. Because of this, the extending portion 22d is thermally connected to the cooler 70 via the heat dissipation member 60.

As explained thus far, in the coil device 300 according to the third embodiment, a set of the terminal portions 21b and 22b and the extending portion 22d in the coil body 20 are positioned on opposite sides of each other relative to the winding axis 10a as the axis of symmetry. Because of this, heat emitted from the plurality of stacked coils forming the coil body 20 in the coil device 300 can be dissipated from the coils on all the layers.

### Fourth Embodiment

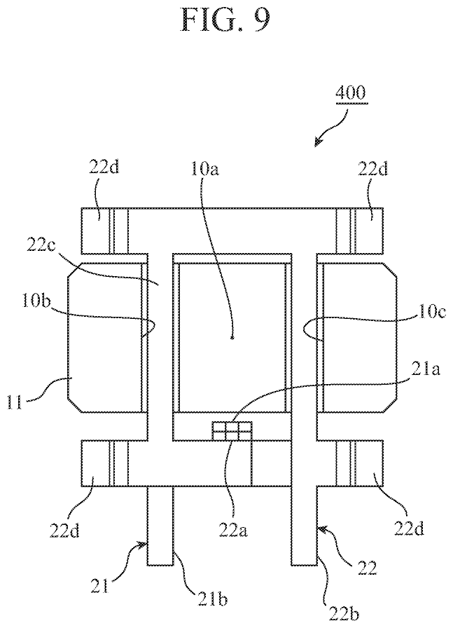

A coil device 400 according to a fourth embodiment is explained by using FIG. 9. FIG. 9 is a plan view in a state where the resin members 30 and the pressing members 50 are removed from the coil device 400 according to the fourth embodiment. In FIG. 9, the split core 12 is omitted. Note that constituent elements having functions which are similar to those of constituent elements explained in the first embodiment mentioned above are given identical reference signs, and explanations thereof are omitted.

In the coil device 100 according to the first embodiment depicted in FIG. 1, the widthwise dimension of the lower-layer coil 21 and the widthwise dimension of the upper-layer coil 22 are both uniform, and are the same. In contrast to this, as depicted in FIG. 9, in the coil device 400 according to the fourth embodiment, the widthwise dimension of the lower-layer coil 21 and the widthwise dimension of the upper-layer coil 22 are both not uniform.

As depicted in FIG. 9, the widthwise dimensions of the extending portions 22d of the upper-layer coil 22 are greater than the widthwise dimension of the terminal portion 21b, and the widthwise dimensions of portions which are part of the winding portion 21c and pass through the coil insertion paths 10b and 10c. In addition, the widthwise dimensions of the extending portions 22d of the upper-layer coil 22 are greater than the widthwise dimension of the terminal portion 22b, and the widthwise dimensions of portions which are part of the winding portion 22c and pass through the coil insertion paths 10b and 10c.

Because of this, in the coil device 400, the widthwise dimensions of the coil insertion paths 10b and 10c of the core 10 can be reduced. As a result, it is possible to attempt to reduce the size and cost of the core 10 of the coil device 400. In addition, it is possible to attempt to enhance the heat dissipation property of the extending portions 22d of the coil device 400.

As explained thus far, in the coil device 400 according to the fourth embodiment, the widthwise dimensions of the extending portions 22d are equal to or greater than the widthwise dimensions of the winding portions 21c and 22c. Because of this, the extending portions 22d in contact with the heat dissipation members 60 can have larger sizes in the coil device 400, so that the heat dissipation property can be enhanced.

### Fifth Embodiment

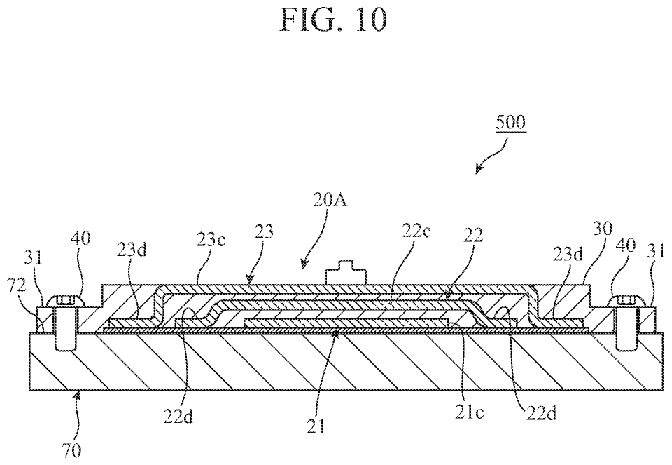

A coil device 500 according to a fifth embodiment is explained by using FIG. 10. FIG. 10 is a vertical cross-sectional view of the coil device 500 according to the fifth embodiment. Note that constituent elements having functions which are similar to those of constituent elements explained in the first embodiment mentioned above are given identical reference signs, and explanations thereof are omitted.

As depicted in FIG. 10, the coil device 500 according to the fifth embodiment includes a coil body 20A instead of the coil body 20 of the coil device 100 according to the first embodiment depicted in FIG. 1. The coil body 20A forms the first coil body.

The coil body 20A has the lower-layer coil 21, the upper-layer coil 22 and an uppermost-layer coil 23. The coil body 20A passes through the coil insertion paths 10b and 10c, and is wound about the winding axis 10a rectangularly and annularly. The uppermost-layer coil 23 is a coil forming a layer immediately above the upper-layer coil 22. A clearance with a predetermined size is formed in the up-down direction between the upper-layer coil 22 and the uppermost-layer coil 23. In addition, the upper-layer coil 22 and the uppermost-layer coil 23 are joined in series. That is, the coil body 20A has a triple-layer structure (triple-turn structure).

The uppermost-layer coil 23 has a winding portion 23c and extending portions 23d. The winding portion 23c and the extending portions 23d are provided inside the resin members 30. The extending portions 23d of the uppermost-layer coil 23 are formed in such a way that the extending portions 23d extend from the outer circumferential surface of the winding portion 23c in directions away from the winding axis 10a, and thereby abut on the surfaces of the heat dissipation members 60 provided on the protrusion surfaces 72. Specifically, the extending portions 23d gradually incline toward the heat dissipation members 60 in a direction outward in the widthwise direction from the outer circumferential surface of the winding portion 23c, and abut on the surfaces of the heat dissipation members 60. Because of this, the extending portions 23d are thermally connected to the cooler 70 via the heat dissipation members 60.

As explained thus far, heat emitted from the plurality of stacked coils forming the coil body 20A in the coil device 500 according to the fifth embodiment can be dissipated from the coils on all the layers.

### Sixth Embodiment

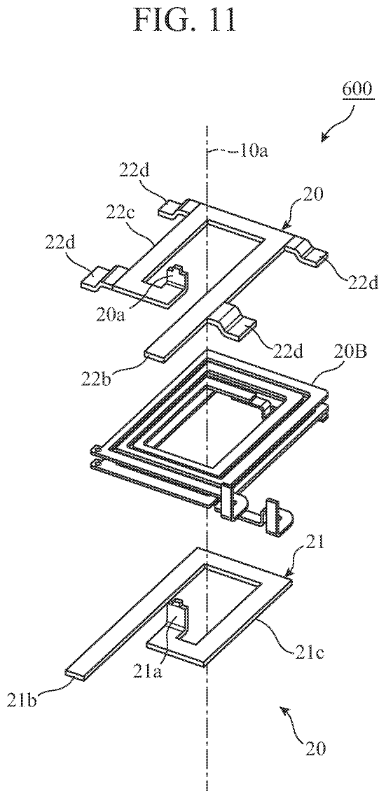

A coil device 600 according to a sixth embodiment is explained by using FIG. 11. FIG. 11 is an exploded perspective view of the coil body 20 included in the coil device 600 according to the sixth embodiment. Note that constituent elements having functions which are similar to those of constituent elements explained in the first embodiment mentioned above are given identical reference signs, and explanations thereof are omitted.

As depicted in FIG. 11, the coil device 600 according to the sixth embodiment has a coil body 20B in addition to the configuration of the coil device 100 according to the first embodiment depicted in FIG. 1. The coil body 20B forms a second coil body.

The coil body 20B is provided between the lower-layer coil 21 and upper-layer coil 22 forming the coil body 20. While the coil body 20 has a dual-layer structure, the coil body 20B has a triple-layer structure or a more multi-layer structure with the number of layers (the number of windings) which is greater than that of the coil body 20. The coil body 20B is thermally connected with the lower-layer coil 21 and upper-layer coil 22 of the coil body 20.

In a case where the coil device 600 is given a step-down function of converting a primary-side high voltage into a secondary-side low voltage, and outputting the secondary-side low voltage, the coil body 20B forms a primary-side coil having a greater number of windings, and the coil body 20 forms a secondary-side coil with a smaller number of windings. At this time, since the extending portions 22d of the coil body 20 forming the secondary-side coil is thermally connected to the cooler 70 via the heat dissipation members 60, heat emitted from the coil body 20 is dissipated to the cooler 70. In addition, heat emitted from the coil body 20B is dissipated to the cooler 70 via the coil body 20 and the heat dissipation members 60.

As explained thus far, the coil device 600 includes the coil body 20B formed with the number of windings greater than the number of windings of the coil body 20. The coil body 20B is disposed coaxially with the coil body 20, and also stacked on the coil body 20. Because of this, even in a case where the coil device 600 is provided with the coil body 20B which is a body separate from the coil body 20, the coil device 600 enables dissipation of heat emitted from the coil body 20B via the upper-layer coil 22 of the coil body 20.

### Seventh Embodiment

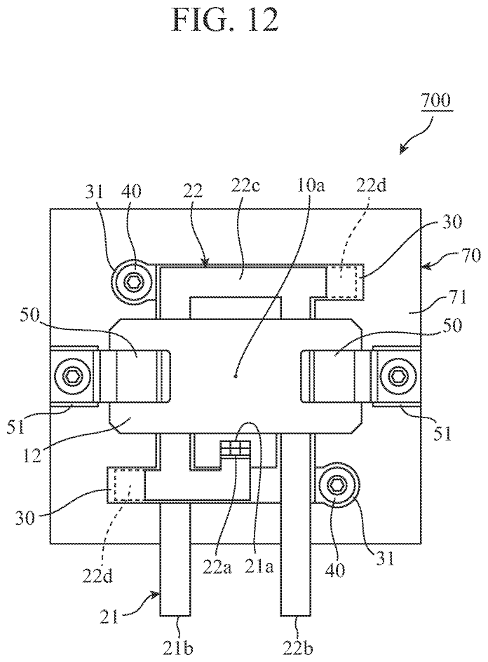

A coil device 700 according to a seventh embodiment is explained by using FIG. 12. FIG. 12 is a plan view of the coil device 700 according to the seventh embodiment. Note that constituent elements having functions which are similar to those of constituent elements explained in the first embodiment mentioned above are given identical reference signs, and explanations thereof are omitted.

The coil device 100 according to the first embodiment depicted in FIG. 1 includes the four extending portions 22d. In contrast to this, as depicted in FIG. 12, the coil device 700 according to the seventh embodiment includes two extending portions 22d.

On each of both sides of the core 10 which are a front side where the joint portion 22a is disposed, and a rear side where the joint portion 22a is not disposed, the upper-layer coil 22 has one extending portion 22d. The two extending portions 22d are arranged on a diagonal line of the winding portion 22c.

A resin member 30 provided to each protrusion surface 72 of the cooler 70 has one fixation portion 31. Each resin member 30 has a fixation portion 31 at an end portion which is part of the resin member 30, and which is positioned on a side opposite to an end portion provided with an extending portion 22d.

Accordingly, it is possible to attempt to reduce the sizes of the coil body 20 and resin members 30 of the coil device 700.

Note that within the scope of the present disclosure, the disclosure allows any combinations of embodiments, modifications of any constituent elements in embodiments and omission of any constituent elements in embodiments.

Several modes of the present disclosure are described below collectively as notes.

(Note 1) A coil device including:
a core mounted on a mounting surface of a cooler;
a first coil body formed by stacking, on the mounting surface, a plurality of coils having winding portions wound about a winding axis of the core; and
a heat dissipation member provided for the cooler, in which
among the plurality of coils, a coil positioned on a layer other than a lowermost layer has an extending portion extending in a direction away from the winding axis, and
the extending portion and a winding portion of a coil positioned on the lowermost layer abut on the heat dissipation member.

(Note 2) The coil device according to Note 1, in which the extending portion and the winding portion of the coil positioned on the lowermost layer are arranged coplanarly.

(Note 3) The coil device according to Note 1 or Note 2, in which at least one end portion of both end portions of the first coil body is disposed coplanarly with the extending portion and the winding portion of the coil positioned on the lowermost layer.

(Note 4) The coil device according to any one of Note 1 to Note 3, including:
a resin member that fixes at least integrally the extending portion and the winding portion of the coil positioned on the lowermost layer; and
a protrusion surface that is formed on the cooler, and disposed at a position higher than a height position of the mounting surface, in which
the heat dissipation member is provided for the protrusion surface, and
the resin member is provided for the protrusion surface in such a way that the resin member covers the heat dissipation member.

(Note 5) The coil device according to Note 4, in which the protrusion surface has a recess housing the heat dissipation member.

(Note 6) The coil device according to any one of Note 1 to Note 5, in which the extending portion is disposed in an area surrounded by core profile lines representing positions of both side surfaces, in a widthwise direction, of the core, and coil profile lines representing positions of both side surfaces, in a front-back direction, of the winding portions.

(Note 7) The coil device according to any one of Note 1 to Note 5, in which the extending portion and a set of both end portions of the first coil body are positioned on opposite sides of each other relative to the winding axis as an axis of symmetry.

(Note 8) The coil device according to any one of Note 1 to Note 7, in which a widthwise dimension of the extending portion is equal to or greater than widthwise dimensions of the winding portions.

(Note 9) The coil device according to any one of Note 1 to Note 8, in which a widthwise dimension of the heat dissipation member is equal to or greater than widthwise dimensions of the winding portions and a widthwise dimension of the extending portion.

(Note 10) The coil device according to any one of Note 1 to Note 9, including a second coil body formed with the number of windings greater than the number of windings of the first coil body, in which the second coil body is disposed coaxially with the first coil body, and also is stacked on the first coil body.

### REFERENCE SIGNS LIST

10: core, 10a: winding axis, 10b, 10c: coil insertion path, 10d: core profile line, 11, 12: split core, 20, 20A, 20B: coil body, 20a: coil profile line, 21: lower-layer coil, 21a: joint portion, 21b: terminal portion, 21c: winding portion, 22: upper-layer coil, 22a: joint portion, 22b: terminal portion, 22c: winding portion, 22d: extending portion, 23: uppermost-layer coil, 23c: winding portion, 23d: extending portion, 30: resin member, 31: fixation portion, 40: fixation member, 50: pressing member, 51: support member, 60: heat dissipation member, 70: cooler, 71: mounting surface, 72: protrusion surface, 72a: recess, 100, 200, 300, 400, 500, 600, 700: coil device

1. A coil device comprising:
a core mounted on a mounting surface of a cooler;
a first coil body formed by stacking, on the mounting surface, a plurality of coils having winding portions wound about a winding axis of the core; and
a heat dissipation member provided for the cooler, wherein
among the plurality of coils, a coil positioned on a layer other than a lowermost layer has an extending portion extending in a direction away from the winding axis, and
the extending portion and a winding portion of a coil positioned on the lowermost layer abut on the heat dissipation member.

2. The coil device according to claim 1, wherein the extending portion and the winding portion of the coil positioned on the lowermost layer are arranged coplanarly.

3. The coil device according to claim 1, wherein at least one end portion of both end portions of the first coil body is disposed coplanarly with the extending portion and the winding portion of the coil positioned on the lowermost layer.

4. The coil device according to claim 1, comprising:
a resin member that fixes at least integrally the extending portion and the winding portion of the coil positioned on the lowermost layer; and
a protrusion surface that is formed on the cooler, and disposed at a position higher than a height position of the mounting surface, wherein
the heat dissipation member is provided for the protrusion surface, and
the resin member is provided for the protrusion surface in such a way that the resin member covers the heat dissipation member.

5. The coil device according to claim 4, wherein the protrusion surface has a recess housing the heat dissipation member.

6. The coil device according to claim 1, wherein the extending portion is disposed in an area surrounded by core profile lines representing positions of both side surfaces, in a widthwise direction, of the core, and coil profile lines representing positions of both side surfaces, in a front-back direction, of the winding portions.

7. The coil device according to claim 1, wherein the extending portion and a set of both end portions of the first coil body are positioned on opposite sides of each other relative to the winding axis as an axis of symmetry.

8. The coil device according to claim 1, wherein a widthwise dimension of the extending portion is equal to or greater than widthwise dimensions of the winding portions.

9. The coil device according to claim 1, wherein a widthwise dimension of the heat dissipation member is equal to or greater than widthwise dimensions of the winding portions and a widthwise dimension of the extending portion.

10. The coil device according to claim 1, comprising a second coil body formed with the number of windings greater than the number of windings of the first coil body, wherein
the second coil body is disposed coaxially with the first coil body, and also is stacked on the first coil body.
